(19) United States
(12) Patent Application Publication
(10) Pub. No.: US 2006/0270390 A1
(43) Pub. Date: Nov. 30, 2006

(54) Call barring system of mobile phone

(75) Inventors: Cheng-Shing Lai, Taipei (TW); Xiao-Long Fan, Nanking (CN); Ai-Lin Shen, Nanking (CN)

Correspondence Address: BACON & THOMAS, PLLC, 625 SLATERS LANE, FOURTH FLOOR, ALEXANDRIA, VA, 22314, US

(73) Assignee: Inventec appliances Corp., Taipei (TW)

(21) Appl. No.: 11/139,641

(22) Filed: May 31, 2005

(51) Int. Cl. H04M 3/42

(52) U.S. Cl. 455/414.1; 455/415

(57) ABSTRACT

A call barring system of mobile phone that applies an intelligent process comprising a first and a second procedures for handling different call barring conditions, wherein the first procedure is used to preset call barring conditions to all the incoming calls and the second procedure is used to recognize caller ID of an incoming call, and bars the incoming call and send a corresponding message back when the incoming call is recognized to meet the call barring condition, and then process the incoming call and store a record thereof into a special directory. Thus, user can check the record and do the necessary later on.

### BACKGROUND OF THE INVENTION

I. Field of the Invention

This invention relates generally to a call barring system and, more specifically to an intelligent call barring system of mobile phone that blocks and processes incoming calls according to preset call barring conditions while user is busy and can not be interrupted.

II. Description of the Prior Art

Heretofore, it is known that communication and network technologies advance rapidly, mobile phones become very popular for their small physical size, powerful in function and lowering cost, mobile phone communication becomes one of the most popular communication methods. Users can talk to friends or business partners instantly for information exchange; mobile phone offers simpler, more convenient and more rapid advantages than traditional phone.

In addition, people's working and life paces are much faster and need instant response in the present world, mobile phones not only can be a rapid communication tool, but also offer many other software, such as games, phone book, voice mail, alarm clock. etc, other extra services for more application can fulfill users' requirements with only one single mobile phone.

Current mobile phones can overcome many inconvenience of tradition phones, however some functions under special circumstances still is not ideal, since some incoming calls can not be treated in special ways that introduces some inappropriate or even unpleasant feeling.

For example, some businessmen have business meeting everyday, or in a very important meeting, users might be doing something that needs highly concentration, or in learning, or waiting for some important messages, under these circumstances, the unexpected calls sometimes make users in dilemma situation whether to pick up the phone or not, such might influence the meeting in progress, or uninterruptible job, or learning something, the sudden call might interrupt users' thinking, or influence other colleagues' attention, that further causes some should not happen conditions, or delays, interrupts something . . . .

On the other hand, once users are afraid conditions mentioned above might happen and shut the mobile phones off, after the meeting completes, users might forget to turn the mobile phones on, the mobile phones are in power-off condition, when users find out the mobile phones are not on, some important business opportunities might be gone, or cause disturbance in human relation.

The disturbance described above needs a solution, in order to avoid users to be interrupted in above circumstances, and to avoid mobile phones are not powered on after they are powered off; if mobile phone manufacturers can design a new phone product that can solve the application problems and offer much convenience and more applicable functions, such makes communication among people with less obstacles and achieve mutual cooperation, more mobility effect, consumers should be very happy to see, manufacturer should also gain more competition among others.

### SUMMARY OF THE INVENTION

Based on the above in depth introduction, we can realize when a user in an occasion and time that is inappropriate to answer calls, but calls coming in unexpectedly, such might cause user in a dilemma situation whether to pick up the phone or not, that further make user feel inappropriate or even unpleasant. Based on market and users' need and to solve the problems described above, the inventor with many years of experience has studied experimented for a long period of time, finally come out with the “call barring system of mobile phone” that can offer users' more convenience on the application of mobile phones.

It is therefore a primary object of the invention to provide a call barring system of mobile phone that applies an intelligent process comprising a first and a second procedures for handling different conditions, wherein the first procedure is to preset call barring conditions to all the incoming calls, the second procedure is to recognize caller ID of the incoming call and then process the incoming call and store a record thereof; when the mobile phone encounters the preset call barring conditions, the system bars the incoming calls according to the preset call barring conditions and, when an incoming call is received by the mobile phone and is recognized to meet the call barring conditions (such as call barring in certain period of time), the mobile phone system bars the call and sends a corresponding message back in response to the incoming call, at the same time, the system processes this incoming call and stores a record into a special directory. Thus, a user of the mobile phone can check the record and do the necessary later on and fulfill the purpose for barring all the incoming calls in certain period of time.

It is still an object for the invention to provide a call barring system of mobile phone which allows users to use input devices (such as keypads) and UI (Users Interface) to preset call barring conditions.

It is still another object for the invention to provide a call barring system of mobile phone having advantages as follows:

1. Users can preset special procedures (intelligent procedures) to all the incoming calls with special conditions during certain period of time that is inappropriate for the users to answer their phones.

2. System stores the caller ID of an incoming call and the record thereof into a special directory (such as call barring directory), users can check the record and do the necessary afterwards.

The accomplishment of the above-mentioned object of the present invention will become apparent from the following description and its accompanying drawings which disclose illustrative an embodiment of the present invention, and are as follows:

### BRIEF DESCRIPTION OF THE DRAWINGS

FIG. 1 is the flow chart of the present invention.

### DESCRIPTION OF THE PREFERRED EMBODIMENT

Along with the popularity of mobile phone, some users under some circumstance cannot do some special processes for incoming phone calls, such might causes inappropriate or even unpleasant for users in some special occasions. According to the above situations, the present invention offers an intelligent call barring system for mobile phones having the structures similar to those products on the market.

In the present invention, the intelligent call barring system is installed inside the mobile phone and comprising a first and a second procedures for handling different conditions, wherein the first procedure is to preset call barring conditions to all the incoming calls, the second procedure is to recognize caller ID of an incoming call and then process the incoming call and store a record thereof; when the mobile phone encounters the preset call barring conditions, the system bars the incoming calls according to the call barring conditions and, when an incoming call is received by the mobile phone and recognized to meet the preset call barring condition (such as call barring in certain period of time), the mobile phone system bars the incoming call and sends a corresponding messages (such as voice messages saying users in busy now, or users in not within service area . . . ) back in response to the incoming call, at the same time, the system processes this incoming call and stores a record thereof into a special directory. Thus, user can check the record and do the necessary later on, and fulfill the purpose of barring all the incoming calls in certain period of time.

The present invention allows users to use input devices (such as keypads, not shown in FIGURE) and UI (Users Interface) to preset call barring conditions.

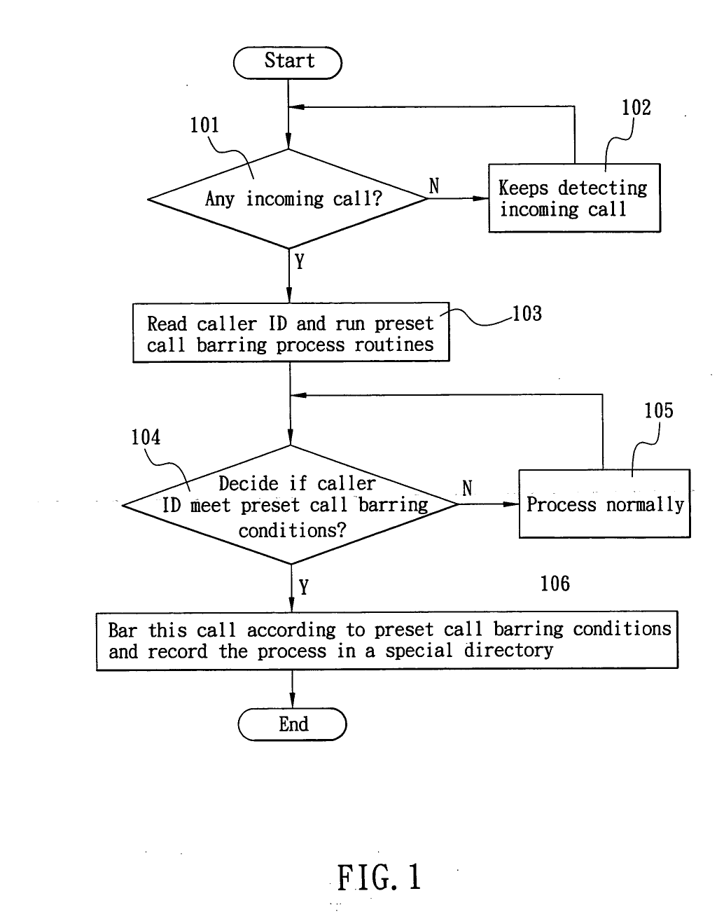

Following description refers to a preferred embodiment of the intelligent call barring system of the present invention, in which user may set call barring function in a mobile phone through using an input device and UI provided thereon to preset call barring conditions. Then, referring to FIG. 1, the intelligent call barring system installed in the mobile phone will proceed process including the following steps:

Step 101: detecting whether there is any incoming call, if there isn't any incoming call, going to step 102, if there is a call, going to step 103;

Step 102: keeping on detecting incoming call;

Step 103: reading caller ID of the incoming call and activating a preset call barring process;

Step 104: determining whether the caller ID meets the preset call barring conditions, if not, then going to step 105; if yes, going to step 106;

Step 105: enabling the mobile phone to be operated in normal condition (such as: answering the call normally);

Step 106: barring the call according to the preset call barring conditions, sending a preset message (such as reminding the caller that user currently is busy, or user currently is not within service area . . . etc.) back in response to the call, processing the incoming call and storing a record thereof in a special directory, and then end the step.

The preset call barring conditions can be set according to the user's real situation.

Based on the above description, the system of mobile phone of the present invention may proceed with procedures of presetting the call barring conditions and processing the incoming call. Therefore, during the period when a user is not available to answer the incoming phone call, the system of the mobile phone can process the incoming calls automatically in accordance with the preset call barring conditions without disturbing the user of the mobile phone. Besides, the system of the mobile phone will send a proper message back in response to the call and then process the incoming call numbers and store the corresponding record into a special directory (such as barring call directory), where the user can check the record later on.

While a preferred embodiment of the invention has been shown and described in detail, it will be readily understood and appreciated that numerous omissions, changes and additions may be made without departing from the spirit and scope of the invention.

What is claimed is:

1. A call barring system of mobile phone comprising a first and a second procedures for processing different call barring conditions, wherein the first procedure is used to preset the call barring conditions to all incoming calls, and the second procedure is used to recognize caller ID of an incoming call and then process the incoming call and store a record thereof, where the system proceeds with a process comprising the following steps when the mobile phone encounters the preset call barring conditions:
barring an incoming call when the incoming call meets the call barring condition, and then sending a corresponding message back in response to the incoming call; and
processing the incoming call and storing a record thereof into a directory preset in the mobile phone.

2. The call barring system of mobile phone recited in claim 1, wherein said call barring conditions are preset by user through input devices and UI.

3. The call barring system of mobile phone recited in claim 1, wherein the system further comprises the following steps while detecting said incoming call:
reading a caller ID of the incoming call and activating a call barring process preset in the mobile phone;
determining whether the caller ID meets the preset call barring condition, if the incoming call meets the preset call barring condition, barring the incoming call according to the preset call barring condition and sending the corresponding message back, and then processing the incoming call and storing a record thereof into the directory.

4. The call barring system of mobile phone recited in claim 3, wherein said message is words representing that a user is currently busy or not within service area.

5. The call barring system of mobile phone recited in claim 3, wherein the call barring condition is to bar the call within certain period of time.

6. The call barring system of mobile phone recited in claim 3, wherein the call barring condition is set by user according to real situation.
